(19) United States
(12) Patent Application Publication
(10) Pub. No.: US 2026/0212868 A1
(43) Pub. Date: Jul. 23, 2026

(54) Bitrate Determinations When Encoding Multiple Audio Elements in a Mix

(71) Applicant: Samsung Electronics Co., Ltd., Suwon-si (KR)

(72) Inventors: Toni Mikael Hirvonen, Santa Clarita, CA (US); Carlos Tejeda Ocampo, Tuxtla Gutierrez (MX); Mahmoud Namazi, Santa Clarita, CA (US)

(21) Appl. No.: 19/338,575

(22) Filed: Sep. 24, 2025

Related U.S. Application Data
(60) Provisional application No. 63/747,701, filed on Jan. 21, 2025.

(51) Int. Cl. G10L 19/002

(52) U.S. Cl. CPC G10L 19/002

(57) ABSTRACT

In one embodiment, a method includes accessing a mix presentation input audio that includes multiple audio elements. The method further includes determining, for each audio element in the mix presentation, a relative perceptual importance of that audio element to the mix presentation; allocating, based on the determined perceptual importances, a bitrate for each audio element; and generating an encoded mix presentation audio stream by encoding each audio element according to the assigned bitrates.

### PRIORITY CLAIM

This application claims the benefit under 35 U.S.C. § 119 of U.S. Provisional Patent Application No. 63/747,701 filed Jan. 21, 2025, which is incorporated by reference herein.

### TECHNICAL FIELD

This application generally relates to bitrate determinations when encoding multiple audio elements in a mix.

### BACKGROUND

A loudspeaker converts an electrical audio signal into a corresponding sound. Loudspeakers can be used for playing music, listening to audio content corresponding to video content (e.g., audio of a TV show or a movie), etc. An entertainment system often involves multiple loudspeakers that play audio. For example, an entertainment system may include a pair of left-right stereo loudspeakers, a subwoofer, a center loudspeaker, a pair of left-right surround loudspeakers, and/or a pair of left-right rear surround loudspeakers. The number of loudspeakers in a system are often referred to by an x.y convention, where x is the number of loudspeakers used in the system and y refers to the number of subwoofers used in the system.

One important aspect of delivering audio for a set of speakers (e.g., home entertainment loudspeakers, headphones, etc.) is audio coding, which involves coding and transmitting audio data with an efficient perceptual quality vs. bitrate tradeoff.

### BRIEF DESCRIPTION OF THE DRAWINGS

FIG. 1 illustrates an example method for determining the bitrate of each of multiple audio elements in a presentation mix.

FIG. 2 illustrates an example method implementing certain techniques of the approach of FIG. 1.

FIG. 3 illustrates a detailed example implementation of a perceptual importance determination technique.

FIG. 4 illustrates an example embodiment in which bitrate allocation and encoding are performed on a frame-by-frame basis.

FIG. 5 illustrates an example embodiment in which metadata is used to adjust bitrate determinations for audio elements.

FIG. 6 illustrates an example computing system.

### DESCRIPTION OF EXAMPLE EMBODIMENTS

Immersive audio can include audio objects, which is an audio track or stem with associated (typically spatial) metadata. Audio objects require a rendering method using the metadata to make the audio listenable for a particular set of speakers. In practice, each audio object is associated with a mono signal.

Audio elements can include one of: 1) a channel-based element such as 7.1, 5.1, stereo, etc.; 2) a scene-based element such as Ambisonics; or 3) an audio object element. Elements can have more than one channel per element; in other words, an element can be represented by multiple channels cₖ per audio element.

A mix presentation is a set of audio elements intended for joint presentation with simultaneous or interactive rendering. For instance, a mix presentation that includes an Ambisonics element along with two stereo elements, where the two stereo elements carry different languages that can be changed, is one example of a mix presentation.

Whether audio content is intended as a mix presentation is usually defined by the content creator and signaled in the transmission format. A mix presentation includes metadata that describes how the audio elements are rendered and mixed together for playback through loudspeakers or headphones in different situations. Unlike in standard audio reproduction, all transmitted audio is typically not rendered together simultaneously. For example, in the case of a sports broadcast, a mix presentation may include 3 audio elements: two stereo languages (e.g. Spanish, English) and a 5.1 multichannel element with a common background, as well as metadata defining how to decode, render and mix these elements and to allow the end user to switch between languages.

For mix presentations, a single bitstream representing the mix encodes multiple audio elements. Encoding should maximize quality while achieving a bitrate that can be efficiently transmitted, and sending multiple audio elements requires allocating the bitrate among those elements. In existing approaches, the elements of a mix presentation are required to be coded with separate audio codec (e.g. Opus) instances. Thus, the bitrates of each mix presentation audio element must be decided before actual transmission, and these bitrates are given to the codec instances as parameters. In addition, simplistic solutions, such as assigning equal bitrate per each audio element in a mix presentation, are suboptimal.

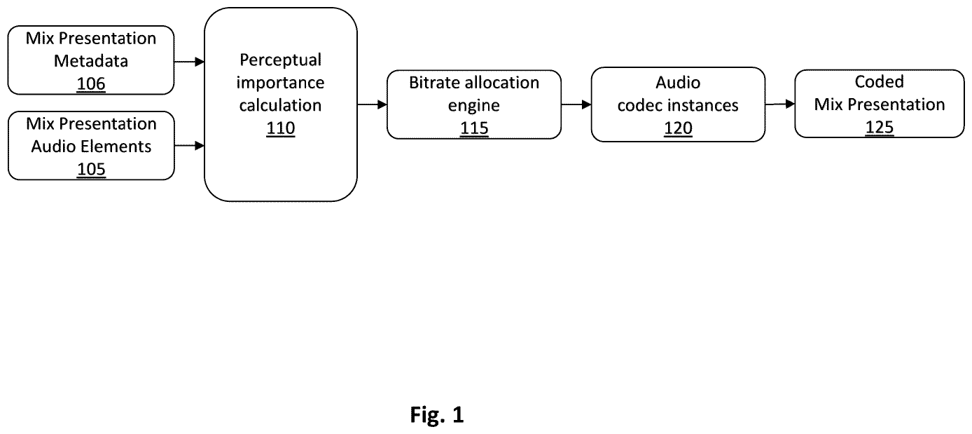

FIG. 1 illustrates an example method for determining the bitrate of each of multiple audio elements in a presentation mix. In the example of FIG. 1, mix presentation audio elements 105 are provided for simultaneous encoding and playback. Mix presentation metadata 106 may also be included, for example to specify a particular gain for a particular element, provide language options, etc.

Perceptual importance calculation 110 determines how each distinct audio element will be encoded, as described more fully below. Bitrate allocation engine 115 takes the output of the perceptual importance calculations 110 and allocates final bitrates to each audio element. Particular embodiments may use three hyperparameters to make this allocation: (1) the total available bitrate for all the audio content; (2) a lower bitrate limit for each element, specifying the lowest bitrate that any particular element can achieve and (3) a maximum bitrate limit for each element, specifying the highest bitrate that element can achieve.

Each codec instance 120 typically processes one audio element, and an input to that instance is a target bitrate for the element. For instance, a stereo audio element and a 5.1 multichannel audio element would each be encoded using a separate codec instance 120. Once each codec instance 120 encodes its audio element, the end result is an encoded mix presentation 125.

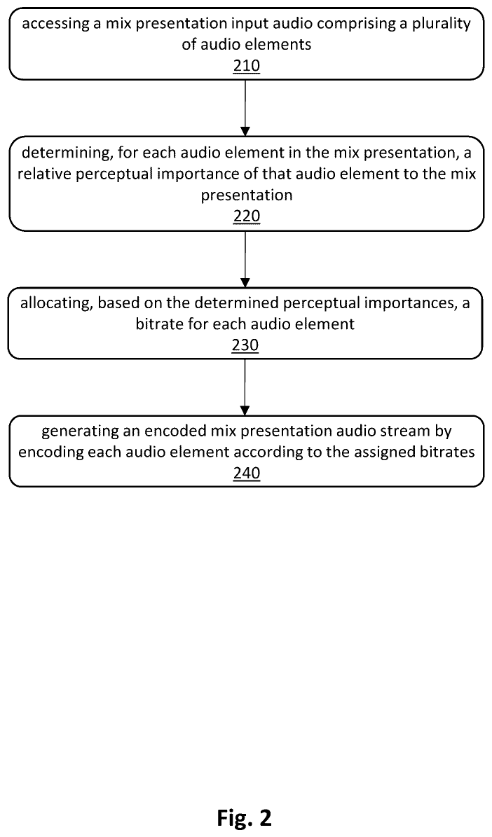

FIG. 2 illustrates an example method implementing certain techniques of the approach of FIG. 1. Step 210 of the example method of FIG. 2 includes accessing a mix presentation input audio that includes multiple audio elements, for instance as shown in element 105 of the example of FIG. 1. Step 220 of the example method of FIG. 2 includes determining, for each audio element in the mix presentation, a relative perceptual importance of that audio element to the mix presentation. Particular embodiments perform step 220 by determining and accounting for channel correlations within each audio element. For example, to account for the channel correlations within each stereo-, multichannel- or scene-based audio element, particular embodiments transform the audio element channel signals with an energy-packing, decorrelating transform, as described more fully below. In this approach, the bitrate requirement mainly depends on the amount of uncorrelated energy of each element.

In particular embodiments, each decorrelating-transformed signal of the audio element is then summed together, and the remainder of the system operates on perceptually weighted band energies of the audio elements in the transformed domain after the correlation analysis and the metadata accounting. Particular embodiments may then use two factors in a perceptual importance measure as described in U.S. Patent Application Publication No. 2025/0046321, which description is incorporated herein by reference. These factors are independent of element channel locations/positional metadata and of decoder rendering. First, a signal that has more total energy needs more bits, compared to a signal that is mostly silent. Particular embodiments may calculate the total energy as the sum of perceptually weighted band energies. Second, particular embodiments may also analyze how much each audio element is masked by the other elements. Particular embodiments can approximate the masking signal by the sum of audio elements: the masking signal (aka “sum signal”) includes all elements of the mix presentation that are deemed as masking the analyzed element at given time. For most situations, a good approximation is that this sum includes all audio elements, but it can include a subset of e.g. the currently active elements in a given presentation. The final unmasking factor can be averaged and normalized over multiple playback presentations with different masking signals, in particular embodiments.

Masking analysis (the second factor) complements total energy determinations (the first factor) with a local unmasking average. The final measure can be calculated as the weighted sum of the two factors with, e.g., relations 0.2 and 0.8, for example. In particular embodiments, a perceptual importance determination can take into account the mix presentation relevant metadata detailing e.g., the possible dynamic changes to the playback levels for each audio element.

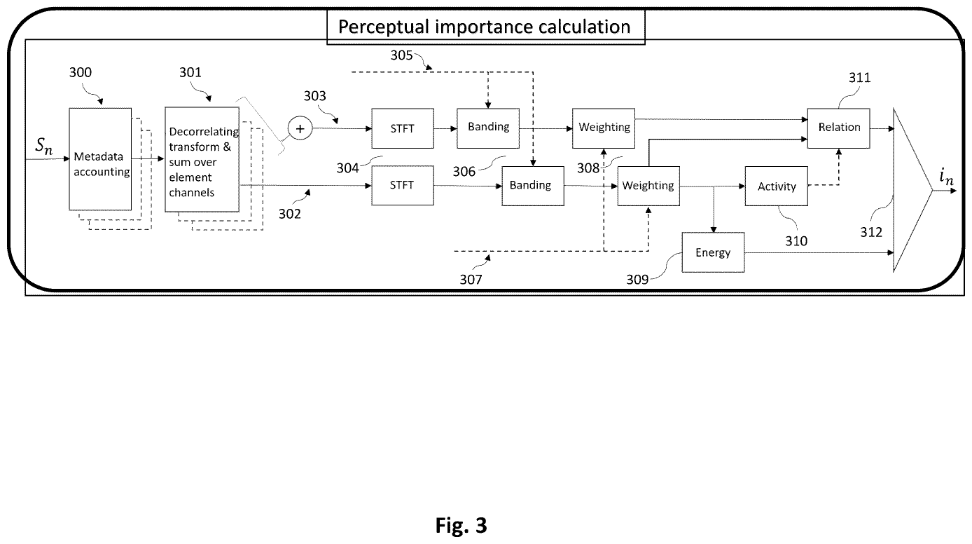

FIG. 3 illustrates a detailed example implementation of a perceptual importance determination technique. In the example of FIG. 3, there are n audio elements, and the n^{th} audio element time domain signal Sₙ is adjusted according to the playback metadata 300 of the mix presentation. An energy-packing, decorrelating transform 301 is used to account for element channel correlations. For instance, particular embodiments may use principal component analysis (PCA) as the decorrelating transform, while other embodiments may use a singular value decomposition, for example.

In order to remove correlations between tracks cₖ in a particular audio element, where cₖ is greater than 1, and then consider only the remaining uncorrelated signals within each element, particular embodiments first represent each audio element Ex of a mix presentation with K elements and multiple tracks cₖ>1 with a single-track signal

$${E}_{k}^{u} ,$$

indicating the sum of the uncorrelated signals:

$${E}_{k}^{u} = {\sum }_{c} {T}_{k} {E}_{k} ,$$

where Eₖ is an audio signal (cₖ×n) matrix with cₖ tracks and n samples. Operation Σ_{c} indicates sum across the element tracks. Tₖ represents a (cₖ×cₖ) matrix obtained with a linear, energy-packing and decorrelating transform such as PCA.

After obtaining the single-track element principal component sum signals

$$[ {E}_{1}^{u} … {E}_{K}^{u} ] ,$$

each element is analyzed in perceptual frequency bands via Short-Time Fourier Transform (STFT), so that the frequency bins are grouped together in bands. The purpose of the banding is to utilize a frequency-dependent weighting mimicking audio codec analysis. For the element signal

$${E}_{k}^{u} ,$$

particular embodiments calculate the perceptually-weighted energy per time-frequency tile (t, i) as

$${e}_{k} ( t , i ) = \frac{{α}_{i}}{{F}_{i}} {\sum }_{f} {\vert STFT ( {E}_{k}^{u} ) ( t , f ) \vert}^{2} ,$$

where i indicates the frequency band index, F the number of bins in the band, and α the predetermined perceptual weights. Operation Σ_{f} sums over the frequency bins within band i. The outcomes of this determination, [e₁(t, i) . . . e_{K}(t, i)], are then used in the perceptual importance calculation, accounting for both 1) the total frequency-weighted energy of the element, and 2) the average measure of how much the element is locally unmasked, results in relative perceptual weights [w₁ . . . wₖ] for all elements of the mix presentation.

In the example of FIG. 3, each of the n audio-element signals are adjusted according to their respective playback metadata, and the decorrelation step 301 is applied to each separate audio-element signal in the mix. For each of the n audio-element signals, the decorrelated components of that signal are summed to form the individual transformed signal for that n^{th} element (illustrated as element 302). In addition, the sum of all transformed signals 303 is used to mask each individual transformed signal 302. In the example of FIG. 3, each individual transformed signal 302 and the sum of all transformed signals 303 are processed via respective Short-Time Fourier Transforms 304. Each STFT signal is grouped into perceptual frequency bands, which bands can originate from the codec. Banding is given via STFT bin indices 305, and the energy of each frequency band normalized by the number of bins in the band is calculated for each time frame 306. A priori relative perceptual importance per frequency band 307 is utilized to weight each band 308 similarly in each the sum signal and the individual element signal. This weighting can originate from the relative bit assignment in the core audio codec, or from an alternative psychoacoustical model. Total perceptual weighted energy is calculated for the element signal 309. Activity detection block 310 is used to find the non-silent segments of the element signal and at those time frames, the perceptual energy of the frequency bands is compared against the perceptual energy of the sum signal, and averaged over time, and then summed over frequency bands 311. The final importance measure iₙ is calculated as the weighted sum of the two factors (total element perceptual energy, and relative energy average compared to sum signal) 312. This process occurs for each n audio element Sₙ in the mix, resulting in a set of n importance measures, each corresponding to a particular audio element.

Aspects of the example of FIG. 3, such as the use of Fourier transforms 304 and the total perceptual energy determination 309, are techniques as described in U.S. Patent Application Publication No. 2025/0046321, which techniques are incorporated herein by reference. However, the example of FIG. 3 relates to mix presentations that include multiple audio elements, not just to single-channel data objects, and as a result, the example of FIG. 3 introduces additional techniques such as metadata accounting and per-audio-element decorrelating transforms 301 in order to take advantage of correlations among audio elements to determine bitrate allocations for a complete mix presentation.

Step 230 of the example method of FIG. 2 includes allocating, based on the determined perceptual importances, a bitrate for each audio element, for instance using bitrate allocation engine 115 of the example of FIG. 1. To obtain the final assigned bitrate per audio element, particular embodiments utilize an interactive algorithm based on perceptual measures [w₁ . . . wₖ], and three hyperparameters: 1) total available bitrate for all audio elements bₜₒₜ, 2) low limit bitrate per type of audio element, and 3) maximum bitrate per type of audio element. Hyperparameters 2 and 3 vary depending of the type of the audio element (and as a function of the codec and the total rate), in particular embodiments. For example, if the quality for stereo saturates at around 128 kbit/s, assigning more rate yields diminishing returns, while potentially harming other elements. This is different for multichannel or HOA elements. The limits can be heuristically assigned. Then, in particular embodiments, an iterative bit reservoir loop assigns the final rates.

Step 240 of the example method of FIG. 2 includes generating an encoded mix presentation audio stream by encoding each audio element according to the assigned bitrates. For instance, FIG. 1 illustrates using audio codec instances 120 (where each instance may be used to encode a particular audio signal in the mix presentation) to collectively generate the coded mix presentation 125 for the input audio elements 105. As described above, the bitrate allocation is based on the perceptual importance of each audio element in the mix relative to the mix as a whole (e.g., based on an importance measure iₙ for each of the n audio elements), and in particular embodiments on hyperparameters such as the overall available bit rate and per-element minimum and maximum bitrates (which may vary based on the element).

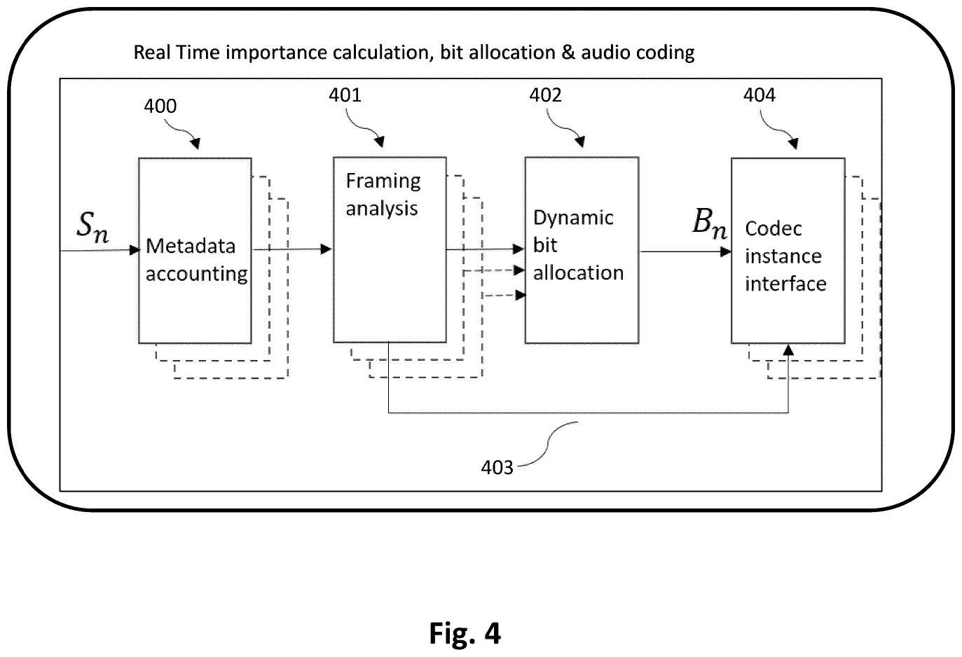

In particular embodiments, each audio element signal Sₙ is the entire temporal audio signal for particular track, and bitrate allocation is determined based on this entire signal. Likewise, each entire signal is encoded by the codec in a given instance. In such embodiments, the decorrelating transform (e.g., step 301) occurs for each full temporal signal, such that decorrelations are determined across that entire signal. Other embodiments may perform bitrate allocation and encoding on a subset of the entire signal, including on a frame-by-frame basis. FIG. 4 illustrates an example embodiment in which bitrate allocation and encoding are performed on a frame-by-frame basis. Each audio element signal Sₙ may first be processed using metadata 401 for that audio element. Then, in the example of FIG. 4, framing analysis 401 determines how long each subsegment, or frame, of the audio element signal will be. Framing information 403 is also synchronized with and used by each codec instance 404 to encode each respective frame. Each frame's worth of information for each audio signal is decorrelated, for instance as described in FIG. 3, and bit allocation 404 is done dynamically once per frame, outputting the rate per audio-element frame Bₙ. This, along with the framing sync information 403, is used as the input for frame processing with the audio codec 404. The codec can also optionally re-use the frequency-domain transform output (e.g. MDCT) from 401 to reduce latency and processing.

Dynamic bitrate allocation 402 can be one of many options, that may include lookback or lookahead. In case a perceptual method as in the example of FIG. 3 is used, step 402 includes both perceptual importance calculation and bit allocation. As a result, unlike conventional encoding in which bitrate and coding decisions are made on the basis of entire input signal (e.g., a whole track), the example of FIG. 4 can dynamically make bitrate and encoding determinations on a frame-by-frame basis, optimizing the correlations within and between audio-element signals on a dynamic basis, rather than assigning bitrate statically to each particular audio-element in a track.

In particular embodiments, codec resource allocation can also be affected by higher-level, content-aware analysis. For instance, in particular embodiments there may be metadata, e.g., from a content creator and/or a machine-learning analysis or classification that can affect allocation. This metadata may be time varying, in particular embodiments. An audio element may have a specified interactive level change in playback, which can be manually indicated during content creation. This can happen, for example, when some users require accessibility (e.g., boosted dialogue). A content creator can also annotate the audio element content type generally, which can help with selecting the appropriate codec rate and other settings, in case the codec operates more efficiently for certain types of content than for others (e.g. for speech).

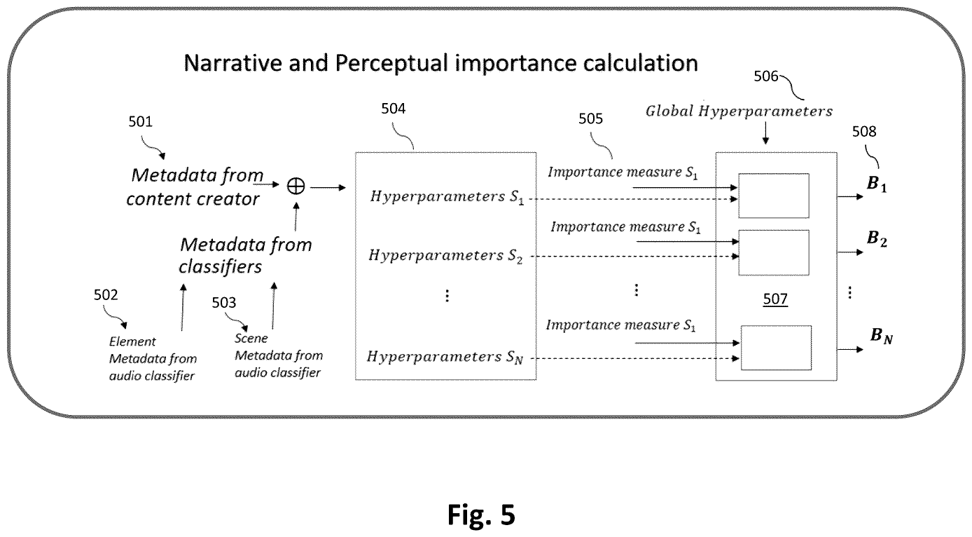

FIG. 5 illustrates an example embodiment in which metadata from a content creator and/or from a classifier is used to adjust bitrate determinations for an audio element. Metadata 501 comes from the content creation process, while metadata 502 comes from a non-context aware classifier model 502 and metadata 503 comes from a context-aware classifier 503 that takes into account scene information corresponding to the audio. These classifiers can take into account both the audio content as well as the rendering and mixing metadata 501, in particular embodiments.

The metadata can be used to adjust hyperparameters for individual audio elements 506 during bitrate allocation 506 after a final importance measure has been computed in 507. These element-specific hyperparameters 504 override global hyperparameters 505 if metadata is present for that particular elements, resulting in content-aware allocation 508.

Classifiers 502 and 503 can be based on machine learning or can be simpler knowledge-based audio processing units. For example, a simple frequency-weighted transient detector can complement the energy-based analysis of FIG. 3: the intensity of the detected transients typically leads to greater bitrate being allocated to the corresponding mix presentation audio element, in order to avoid audible distortion.

In particular embodiments, in situations where the end user rendering is known, pre-rendering can be performed at the encoder, which may lead to a reduction in the number of mix presentation audio elements or the channels within each element, thus allowing for greater bitrate to the remaining elements or channels. In such embodiment, the decoder communicates the end-user reproduction device system and algorithms to the encoder (e.g. in a streaming situation). In some cases, this may mean changing the mix presentation audio element type (i.e. from Ambisonics to stereo).

The techniques described herein result in high-quality compression of mix presentation audio signals that contain multiple audio elements, thereby improving the efficiency of content transmission while still retaining audio quality (e.g., based on perceptual importance).

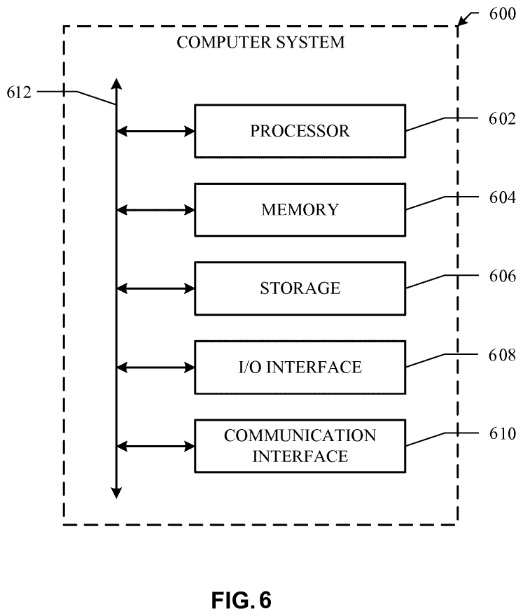

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing a mix presentation input audio comprising a plurality of audio elements;
determining, for each audio element in the mix presentation, a relative perceptual importance of that audio element to the mix presentation;
allocating, based on the determined perceptual importances, a bitrate for each audio element; and
generating an encoded mix presentation audio stream by encoding each audio element according to the assigned bitrates.

2. The method of claim 1, wherein determining, for each audio element in the mix presentation, a relative perceptual importance of that audio element to the mix presentation comprises generating a decorrelated transform of each audio element.

3. The method of claim 2, further comprising masking each decorrelated transform based on a collective sum of each of the decorrelated transforms.

4. The method of claim 3, wherein allocating a bitrate for each audio element is further based on a total bitrate for the mix presentation.

5. The method of claim 4, wherein allocating a bitrate for each audio element is further based on one or more of (1) a minimum bitrate for at least one audio element or (2) a maximum bitrate for at least one audio element.

6. The method of claim 4, wherein allocating a bitrate for each audio element is further based on metadata for that audio element.

7. The method of claim 6, wherein the metadata is defined by one or more of (1) a content creator of the mix presentation or (2) a classification of the mix presentation.

8. The method of claim 3, further comprising generating a series of frames representing the mix presentation and allocating bitrate to each audio element on a frame-by-frame basis.

9. A system comprising one or more non-transitory computer readable storage media storing instructions; and one or more processors coupled to the one or more non-transitory computer readable storage media and operable to execute the instructions to:
access a mix presentation input audio comprising a plurality of audio elements;
determine, for each audio element in the mix presentation, a relative perceptual importance of that audio element to the mix presentation;
allocate, based on the determined perceptual importances, a bitrate for each audio element; and
generate an encoded mix presentation audio stream by encoding each audio element according to the assigned bitrates.

10. The system of claim 9, wherein determining, for each audio element in the mix presentation, a relative perceptual importance of that audio element to the mix presentation comprises generating a decorrelated transform of each audio element.

11. The system of claim 10, further comprising one or more processors that are operable to execute the instructions to mask each decorrelated transform based on a collective sum of each of the decorrelated transforms.

12. The system of claim 11, wherein allocating a bitrate for each audio element is further based on a total bitrate for the mix presentation.

13. The system of claim 12, wherein allocating a bitrate for each audio element is further based on one or more of (1) a minimum bitrate for at least one audio element or (2) a maximum bitrate for at least one audio element.

14. The system of claim 12, wherein allocating a bitrate for each audio element is further based on metadata for that audio element.

15. The system of claim 14, wherein the metadata is defined by one or more of (1) a content creator of the mix presentation or (2) a classification of the mix presentation.

16. The system of claim 11, further comprising one or more processors that are operable to execute the instructions to generate a series of frames representing the mix presentation and allocating bitrate to each audio element on a frame-by-frame basis.

17. One or more non-transitory computer-readable storage media storing instructions that are operable when executed by one or more processors to:
access a mix presentation input audio comprising a plurality of audio elements;
determine, for each audio element in the mix presentation, a relative perceptual importance of that audio element to the mix presentation;
allocate, based on the determined perceptual importances, a bitrate for each audio element; and
generate an encoded mix presentation audio stream by encoding each audio element according to the assigned bitrates.

18. The media of claim 17, wherein determining, for each audio element in the mix presentation, a relative perceptual importance of that audio element to the mix presentation comprises generating a decorrelated transform of each audio element.

19. The media of claim 18, further comprising one or more processors that are operable to execute the instructions to mask each decorrelated transform based on a collective sum of each of the decorrelated transforms.

20. The media of claim 19, wherein allocating a bitrate for each audio element is further based on a total bitrate for the mix presentation.
